(19) United States
(12) Patent Application Publication
(10) Pub. No.: US 2008/0145047 A1
(43) Pub. Date: Jun. 19, 2008

(54) Method of Determining Delay in an Adaptive Path Optical Network

(76) Inventor: Miguel De Vega Rodrigo, Woluwe St. Lambert Brussels (BE)

Correspondence Address: BELL, BOYD & LLOYD, LLP, P.O. BOX 1135, CHICAGO, IL, 60690, US

(21) Appl. No.: 11/578,467

(22) PCT Filed: Feb. 2, 2005
(86) PCT No.: PCT/EP2005/001404

§ 371 Date: Oct. 13, 2006

(30) Foreign Application Priority Data
Apr. 13, 2004 (GB) 0408206.1

(51) Int. Cl. H04B 10/08

(52) U.S. Cl. 398/25

(57) ABSTRACT

A method of determining delay in an end-to-end path of an adaptive path optical network, the method comprising deriving average IP packet delay from the product of average link utilisation of IP packets in the network being sent in bursts and delay in two way reservation optical burst switching networks, wherein the average link utilisation in the network being sent in bursts is the ratio of average throughput sent in bursts in bits per second, to capacity at a bottleneck link in the end-to-end path in the network.

### CROSS REFERENCE TO RELATED APPLICATIONS

This application is the US National Stage of International Application No. PCT/EP2005/001404, filed Feb. 2, 2005 and claims the benefit thereof. The International Application claims the benefits of Great Britain application No. 0408206.1 GB filed Apr. 13, 2004, both of the applications are incorporated by reference herein in their entirety.

A method of determining delay in an end-to-end path of an adaptive path optical network, the method comprising deriving average IP packet delay from the product of average link utilisation of IP packets in the network being sent in bursts and delay in two way reservation optical burst switching networks, wherein the average link utilisation in the network being sent in bursts is the ratio of average throughput sent in bursts in bits per second, to capacity at a bottleneck link in the end-to-end path in the network.

This invention relates to a method of determining delay in an end-to-end path of an adaptive path optical network (APON).

APON networks are able to send internet protocol (IP) packets on the fly between consecutive bursts. This allows edge nodes to empty their aggregation buffers sending IP packets between bursts. Consequently the formation of a burst takes longer, that is, bursts are sent with a lower frequency. This implies a lower average link utilization which is why APON networks show a better performance by comparison with optical burst switching (OBS) or λ-switching networks. It is desirable that a design which optimises the network for a required performance level can be obtained.

In accordance with the present invention, a method of determining delay in an end-to-end path of an adaptive path optical network comprises deriving average IP packet delay from the product of average link utilisation of IP packets in the network being sent in bursts and delay in two way reservation optical burst switching networks, wherein the average link utilisation in the network being sent in bursts is the ratio of average throughput sent in bursts in bits per second to capacity at a bottleneck link in the end-to-end path in the network.

The present invention determines the delay in an APON network for each end-to-end path so that the network design can be optimised to meet desired minimum delay requirements. Average delay in an end-to-end path of an APON depends only on the average link utilisation of the IP packets sent in bursts, not in the λ-switching regime.

Preferably, the average throughput sent in bursts comprises the product of the burst arrival rate in the bottleneck link and the average burst size.

Preferably, the average link utilisation in the bottleneck link of the end-to-end path in the network being sent in bursts is the ratio of the sum from 1 to N of the product of the average throughput to the edge node i and the probability that the burst is sent through the network without being blocked minus the stun from 1 to N of the product of the average throughput to the edge node i and the probability that an IP packet or burst which is being sent through the bottleneck link comes from the edge node i; to the capacity minus the sum from 1 to N of the product of the average throughput to the edge node i and the probability that an IP packet or burst which is being sent through the bottleneck link comes from the edge node i.

The average throughput and the average IP packet delay in the end-to-end path depend upon the average link load of the bottleneck link of the end-to-end path alone. The rest of the links in this path do not influence the APON's performance.

An example of a method of determining delay in an end-to-end path of an adaptive path optical network in accordance with the present invention will now be described with reference to the accompanying drawings in which:—.

FIG. 1 is an analytical model of an end-to-end path in an adaptive path optical network to which the method of the present invention can be applied;

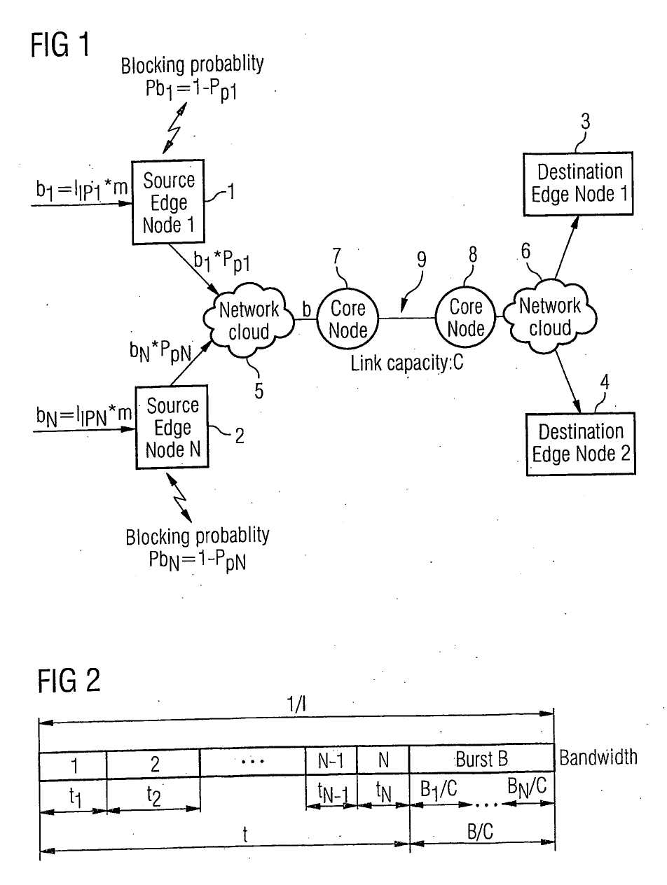

FIG. 2 shows bandwidth utilisation of the bottleneck link of the end-to-end path of FIG. 1;

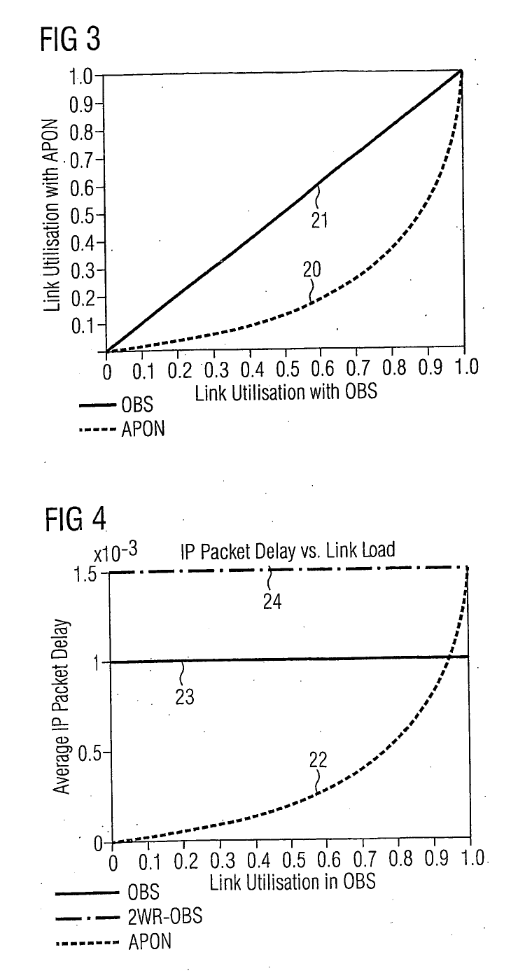

FIG. 3 compares utilisation factor in the bottleneck link of an end-to-end path in an adaptive path optical network compared with an OBS network; and,

FIG. 4 illustrates average IP packet delay in an end-to-end path as a function of the link load in its bottleneck link for OBS, two-way reservation (2WR)-OBS and APON networks.

FIG. 1 is an analytical model of an end-to-end path in an APON network in which source edge nodes 1, 2, of which there can be from 1 to N, are connected to corresponding destination nodes 3, 4 through networks 5, 6 via core nodes 7, 8 and a bottleneck link 9 of capacity C. The bottleneck link of an end to end path is defined as the link in this path with the highest average link utilization. This link has a great impact on the network performance since it will lead to the highest blocking probability in the path and it will be responsible for most of the delay experienced by the IP packets (or bursts) sent through the path. For this reason this link has been chosen as a reference for performance comparison in the corresponding end-to-end path and the average link utilization in the bottleneck link 9 is calculated. Blocking in an end-to-end path of a two way reservation network such as APON takes place at the source edge nodes 1, 2, whenever they receive a no acknowledgment (NACK) signal from the destination edge node 3, 4 as an answer to their path setup request.

This blocking can be modelled simply with a certain blocking probability Pbᵢ in the source edge nodes 1, 2. In order to simplify notation, the probability that a burst is sent through, the path without being blocked Pₚ_{ᵢ} is given as Pₚ_{ᵢ}=1−Pbᵢ. The incoming average IP packet throughput to edge node i is bᵢ in bits per second. If A up is the average IP packet arrival rate, and μ is the average IP packet size (the same for all connections), the equation for edge node i follows:

bᵢ=λ_{IPi}*μ=λᵢ*Bᵢ+λ_{ioffered}*(1−Pₚ_{ᵢ})*Bᵢ Equation 1

Where λᵢ is the average burst arrival rate in the optical link, Bᵢ is the average burst size for this traffic source, λ_{ioffered} is the average burst arrival rate offered to the optical link and (1-Pₚ_{ᵢ}) is the proportion of bursts blocked in the edge node. The interpretation of this equation is that what comes into an edge node must go out, since no information is created or destroyed inside the node. The left hand side of equation 1 describes the average IP packed throughput coming to the edge node. This throughput must be equal to what leaves the node on the other side, which is described by the right hand side of the equation. The right hand side is the sum of two terms, the first of these representing the average throughput of the IP packets which have already been transformed into bursts and are offered to the optical network and the second term represents the average throughput of EP packets which have been blocked and thrown away.

Only the bursts which were not blocked have access to the optical link, so λᵢ=λ_{ioffered}*Pₚ_{ᵢ}.

In APON networks the whole bandwidth of the bottleneck link in an end-to-end path is used, since IP packets are sent on the fly between consecutive bursts. FIG. 2 illustrates this. The expression 1/λ represents the average burst inter-arrival time, that is the time elapsed between the arrival of two consecutive bursts. This time is filled with the transmission time of a burst, B, which lasts B/C seconds in a link of capacity C, and with a transmission time, t of IP packets on the λ-switching regime in which IP packets are sent on-the-fly.

The time t can be broken down into tᵢ, iε(1, . . . , N), which represents the proportion of the time in the λ-switching regime, in which IP packets from source i are sent on-the-fly. In order to accomplish this, it is necessary to introduce pᵢ, iε(1, . . . , N), which represents the probability that an IP packet or a burst which is being sent through the bottleneck link comes from the traffic source i. This can be calculated based on the average arrival rates of the bursts from each traffic source, λᵢ as pᵢ=λᵢ/λ where λ is the average burst arrival rate at the link.

The more IP packets a traffic source sends, the more probable it is that a certain IP packet transmitted in the λ-switching regime in the bottleneck link belongs to this source. Therefore, the probability pᵢ that an IP packet in the bottleneck link was sent by the edge node i will determine the average length tᵢ of the λ-switching regime of this source. In particular, tᵢ=pᵢ*t, where t is the total average length of the λ-switching regime as shown in FIG. 2.

In the λ-switching regime, an edge node forwards the incoming average IP packet throughput bᵢ to the network. Therefore, the amount of bits transferred from each traffic source i in its λ-switching regime of length tᵢ seconds is tᵢ*bᵢ=pᵢ*t*bᵢ, where bᵢ is the average IP packet throughput arriving at the traffic source i.

Analogously to what was done with t, B can also be broken down into Bᵢ with the help of the probabilities pᵢ as follows:

$$B = {\sum }_{i = 1}^{N} {p}_{i} \cdot {B}_{i} \qquad Equation 2$$

That is, the average burst size is the average burst size of the first source edge node with a probability p₁, of the second source edge node with a probability p₂ and so on.

According to this and to FIG. 2, the average throughput b in the bottleneck can be formulated as:

$$b = λ \cdot [ B + t \cdot {\sum }_{i = 1}^{N} {p}_{i} \cdot {b}_{i} ] \qquad Equation 3$$

Where the first term of the addition represents the amount of bits sent in bursts for all traffic sources and the second term represents the sum of the amount in bits sent in the λ-switching regime for each one of the N traffic sources.

According to FIG. 2 the length t of the λ-switching regime can be expressed as

$$t = \frac{1}{λ} - \frac{B}{C} = \frac{C - B \cdot λ}{λ \cdot C} \qquad Equation 4$$

So that the average throughput b can be reformulated as:

$$b = λ \cdot [ B + \frac{C - B \cdot λ}{C \cdot λ} \cdot {\sum }_{i = 1}^{N} {p}_{i} \cdot {b}_{i} ] \qquad Equation 5$$

Solving for λᵢ the average burst arrival rate in the bottleneck link:

$$λ = \frac{{\sum }_{i = 1}^{N} {b}_{i} \cdot {Pp}_{i} - {\sum }_{i = 1}^{N} {b}_{i} \cdot {p}_{i}}{B [ 1 - \frac{{\sum }_{i = 1}^{N} {b}_{i} \cdot {p}_{i}}{C} ]} \qquad Equation 6$$

This expression depends on input parameters at the IP packet level except for the average burst size in the bottleneck B. This size is however exactly the same as in the OBS case, since switching on or off APON functionalities in an OBS network does not change the way in which bursts are made up from the aggregation of IP packets. That is, the burst aggregation strategies remain the same, and therefore the burst sizes as well. So, the average burst size B can be calculated as a function of the average burst size generated per traffic source Bᵢ according to equation 2. The average burst size Bᵢ generated by each traffic source can be calculated from the IP traffic parameters according to the corresponding aggregation strategy used in each edge node.

In order to obtain a delay expression for APON networks, it is necessary to divide the average link utilization ρ_{APON} into two terms. The first of these is the average link utilisation of IP packets which are being sent in the λ-switching regime, and the second one is the average link utilisation of IP packets which are being sent in bursts. The first one is referred to as ρ_{APON}_{_{—}}_{λ-switching} and the second one is referred to as ρ_{APON}_{_{—}}_{OBS}. The definitions of each link utilisation factor are as follows:

$$\begin{matrix}{ρ}_{APON\_λ \text{-} switching} = \frac{bps sent in the λ \text{-} switching regime}{C} \\ = \frac{\frac{C - λ \cdot B}{C} {\sum }_{i = 1}^{N} {p}_{i} \cdot {b}_{i}}{C}\end{matrix} \qquad Equation 7$$

This expression comes from the right hand side of equation 3.

$$\begin{matrix}{ρ}_{APON\_OBS} = \frac{bps sent as bursts}{C} \\ = \frac{λ \cdot B}{C}\end{matrix} \qquad Equation 8$$

This expression comes from the left hand side of equation 3.
Equation 8 is needed in order to calculate the average IP packet delay in APON networks, so it will be expressed as a function of the input IP traffic parameters:

$${ρ}_{APON\_OBS} = \frac{{\sum }_{i = 1}^{N} {b}_{i} \cdot {Pp}_{i} - {\sum }_{i = 1}^{N} {b}_{i} \cdot {p}_{i}}{[ C - {\sum }_{i = 1}^{N} {b}_{i} \cdot {p}_{i} ]} \qquad Equation 9$$

For the calculation of the average IP packet delay in APON networks, the delay experienced by an IP packet in OBS networks can be expressed as the addition of two terms. These are the time that the packet expends in the Edge node (t_{edge}) while the burst is being formed and the delay experienced while the switches along the path are being configured (tₛₑₜᵤₚ).

According to this, the average IP packet delay in 2WR-OBS networks is:

$$E [ {Delay}_{2 WR \text{-} OBS} ] = \frac{{t}_{edge}}{2} + {t}_{setup} = \frac{{t}_{edge}}{2} + {t}_{RTT} \qquad Equation 10$$

where t_{RTT} is the average round trip time for a header packet due to the two-way reservation.

Once the circuits have been established in a static λ-switching network the packets experience no delay and no delay jitter, only the usual propagation delay, when being transmitted through the network. Therefore the packet delay (and delay jitter) during the operation of a λ-switching network is zero.

$$E [ {Delay}_{λ \text{-} switching} ] = 0 \qquad Equation 11$$

APON networks have a lower delay than 2WR-OBS networks, due to the fact that packets transmitted in the λ-switching regime experience no delay (and no delay jitter). The network load determines the proportion of IP packets being transferred in the λ-switching regime, which determines whether the total average delay will tend to the delay in λ-switching networks (zero delay) or to the delay in 2WR-OBS networks. If ρ_{APON-λ-switching} is the average link load of IP packets sent in the λ-switching regime and ρ_{APON-OBS} is the average link load of IP packets sent in bursts in the bottleneck link of a given end-to-end path, the average delay in this path of the APON network can be calculated as follows:

$$E [ {Delay}_{AOPN} ] = {ρ}_{APON \text{-} λ \text{-} switching} \cdot E ⌊ {Delay}_{λ \text{-} switching} ⌋ + \\ + {ρ}_{APON \text{-} OBS} \cdot E [ {Delay}_{2 WR \text{-} OBS} ] \qquad Equation 12$$

Since the delay in λ-switching networks is zero, the equation can be simplified as follows:

$$E [ {Delay}_{AOPN} ] = {ρ}_{APON \text{-} OBS} \cdot E [ {Delay}_{2 WR \text{-} OBS} ] \qquad Equation 13$$

As the link utilization ρ is always below 1, the equation above demonstrates that the delay in APON networks is below that in 2WR-OBS networks. For link utilization loads close to zero, the delay tends to zero, which expresses the fact that in this case most of the IP packets are sent through the path in the λ-switching regime and not in bursts. For high utilization loads (close to one), the delay tends to the delay in 2WR-OBS networks, expressing the fact that in this case most of the IP packets are sent in bursts. The derived mathematical formula of Equation 9 enables the link utilization factor in APON networks to be calculated, as well as using this formula as the basis for the APON delay formula of equation 13.

Advantages of the method of the present invention include the fact that it is an exact method, since no approximations of any kind are made; it is valid for any kind of traffic statistics, such as Poisson traffic or self similar traffic, which allows the model to be used in access as well as in core networks; and it is valid for any APON network topology. The method is easy to implement and to calculate, which makes it suitable for its implementation in APON edge nodes, APON core nodes or in planning tools; and it allows comparison of the performance of APON, OBS and λ-switching networks in terms of delay.

The graphs of FIGS. 3 and 4 illustrate an example of link utilization and of delay as a function of the network load that can be obtained with the method of the present invention. It can be seen from FIG. 3 that the average link utilization in APON networks 20 is always below the average link utilization in OBS networks 21 except for the unrealistic link utilization values of 0 and 1. This is the reason why the performance of APON networks in terms of blocking probability and delay is always higher. For medium to high loaded networks, i.e. for link utilization between 0.4 and 0.8, the reduction of the link utilization in APON networks compared to OBS networks is at its maximum. This makes it a very attractive working area for any optical network.

In FIG. 4, the delay in APON networks 22 is shown to be far below the delay in OBS networks 23 at 1×10⁻³ and in 2WR-OBS networks 24 at 1.5×10⁻³. This applies for link utilizations below 0.9. This is again the ideal working area of any optical network. The performance increase in terms of delay of APON networks is higher with lower link utilizations.

The present invention provides a method of determining average delay in an adaptive path optical network. This includes calculating link utilization in APON networks in a way which is exact and valid for any burst size distribution, and any inter-arrival time distribution between bursts, i.e. not only for Poisson traffic. The derived delay formula for APON networks is based on the new link utilization calculation. The delay formula can be used to calculate the average IP packet delay in any APON network. This formula has several applications including use as a planning tool—to design APON networks that fulfil a certain maximum allowed delay; use in APON edge nodes as the core of an admission control mechanism that accepts or rejects bursts depending on whether the additional load makes the average network delay exceed a certain limit or not; use in helping a routing algorithm to balance a load, so that all end to end paths have approximately the same average delay; and use in helping a quality of service (QoS) routing algorithm to route high-priority bursts through lower delay paths.

1. A method of determining delay in an end-to-end path of an adaptive path optical network, the method comprising deriving average IP packet delay from the product of average link utilisation of IP packets in the network being sent in bursts and delay in two way reservation optical burst switching networks, wherein the average link utilisation in the network being sent in bursts is the ratio of average throughput sent in bursts in bits per second, to capacity at a bottleneck link in the end-to-end path in the network.

2. A method according to claim 1, wherein the average throughput sent in bursts comprises the product of the burst arrival rate in the bottleneck link and the average burst size.

3. A method according to claim 1, wherein the average link utilisation in the bottleneck link of the end-to-end path in the network being sent in bursts is the ratio of the sum from 1 to N of the product of the average throughput to the edge node i and the probability that the burst is sent through the network Without being blocked minus the sum from 1 to N of the product of the average throughput to the edge node i and the probability that an IP packet or burst which is being sent through the bottleneck link comes from the edge node i; to the capacity minus the sum from 1 to N of the product of the average throughput to the edge node i and the probability that an IP packet or burst which is being sent through the bottleneck link comes from the edge node i.
